(19) United States
(12) Patent Application Publication
(10) Pub. No.: US 2016/0083510 A1
(43) Pub. Date: Mar. 24, 2016

(54) BLOCK COPOLYMER AND PROCESS FOR PREPARING THE SAME

(71) Applicant: SAUDI BASIC INDUSTRIES CORPORATION, RIYADH (SA)

(72) Inventors: Robbert DUCHATEAU, GELEEN (NL); Miloud BOUYAHYI, GELEEN (NL); Lidia JASINSKA-WALC, GELEEN (NL)

(21) Appl. No.: 14/890,967

(22) PCT Filed: May 20, 2014
(86) PCT No.: PCT/IB2014/061566

§ 371 Date: Nov. 13, 2015

(30) Foreign Application Priority Data
May 23, 2013 (EP) 13002687.5

(51) Int. Cl. C08G 63/83; C08G 63/02

(52) U.S. Cl. CPC C08G 63/83; C08G 63/02

(57) ABSTRACT

The invention relates to a block copolymer comprising a first block of general structure formula (II) and a second block of general structure formula (III) wherein Rx is an organic group having a chain length of from 1-9 atoms; R^{y} is an organic group having a chain length of from 10-38 atoms; n₁ is at least 2; n₂ is at least 2. The invention further relates to a method for preparing such block copolymer using as a catalyst a phenoxy-imine based catalyst having general structure of formula I.

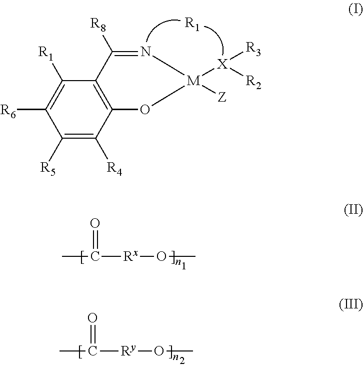

The present invention relates to a block copolymer of at least two polyester blocks. The present invention further relates to a method for preparing such block copolymer.

Polyesters are interesting materials because of their properties which, for instance, include biocompatibility, biodegradability, and drug permeability. In addition they may exhibit preferred barrier properties, in particular oxygen barrier properties, when used in film applications. Therefore, polyesters are of great interest for medical and food packaging applications. For these purposes materials with an engineered structure are desired, which implies the need for a high level of control over the polymerization reaction. In addition, with the right properties, certain polyesters can form an interesting biodegradable alternative for polyethylene in various applications.

Block co-polyesters, i.e. block-copolymers containing two or more different polyester blocks, provide a further degree of freedom in the material design. By selection of the type of block structure, the type of monomers and the length of the respective blocks unique materials may be obtained with properties that suit a specific need.

U.S. Pat. No. 6,486,296 discloses a method to regulate a copolymer structure using lipase catalyzed transesterification reactions. In U.S. Pat. No. 6,486,296 methods are disclosed by which lipases catalyze the formation of copolymers by reactions between two or more preformed polyesters, polyester and a monomer (such as lactone or cyclic carbonate), a polycarbonate and a monomer, and reactions between two or more monomers. The method to regulate copolymer structure using lipase catalyzed transesterification reactions disclosed in this patent comprises the general steps of selecting a first reactant from the group consisting of polymers and monomers, selecting a second reactant from the group consisting of polymers and monomers, and combining the first reactant, the second reactant, and a lipase in a reaction vessel and allowing the ensuing transesterification reaction to proceed resulting in a desired polymer. A disadvantage of the method of U.S. Pat. No. 6,486,296 is that the underlying mechanism for the forming of copolymers is that of transesterification, which inherently will result in certain randomness in the type of copolymers. As such the method of U.S. Pat. No. 6,486,296 is believed to result in “blocky” copolymers at most, rather than true block copolymers having a sharp transition dividing the different blocks. In addition the method does not allow an accurate control on either one or more of copolymer block structure, block length, molecular weight, polydispersity index.

The copolymerisation of lactones having a small ring size is known for example from WO 2010/110460, which discloses a method for producing a lactide/ε-caprolactone copolymer whereby a lactide/ε-caprolactone copolymer being close to an ideal random copolymer can be produced while controlling the molecular weight and the molecular weight distribution. The copolymerisation method disclosed in WO 2010/110460 was carried out using an aluminium-salen complex as a catalyst.

Copolymers of ω-pentadecalactone (PDL) and ε-caprolactone (CL), i.e. a copolymer of a small ring size lactone and a large ring size lactone has been disclosed by Bouyahyi et al (Bouyahyi, M. et al., Macromolecules 2012, 45, 3356-3366). This article discloses that 1,5,7-triazabicyclo[4.4.0]dec-5-ene (TBD) in combination with benzyl alcohol (BnOH) as initiator is an active catalyst for the copolymerisation of ω-pentandecalactone and ε-caprolactone. As a result of rapid competitive intra- and intermolecular transesterification only random copolymers were obtained.

In view of the above art it would be desirable to provide one or more of the following: true block co-polyesters containing one or more blocks wherein ester functionalities are linked by relatively short chains, and containing one or more blocks wherein ester functionalities are linked by relatively long chains; such true block co-polyesters further having a well-defined block copolymer structure. It would be further advantage to provide a method for preparing true block co-polyesters containing one or more blocks wherein ester functionalities are linked by relatively short chains, and containing one or more blocks wherein ester functionalities are linked by relatively long chains.

### SUMMARY

To that extent the present invention provides a block copolymer comprising a first block of general structure

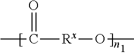

and a second block of general structure

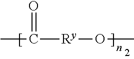

wherein

R^{x} is an organic group having a chain length of from 1-9 atoms;

R^{y} is an organic group having a chain length of from 10-38 atoms;

n₁ is at least 2; and

n₂ is at least 2.

### BRIEF DESCRIPTION OF THE DRAWINGS

The following Figures which are not limiting in any way.

FIG. 1 shows a DSC plot for two block copolymers according to the present invention.

FIG. 2 shows a DSC plot of CL/PDL random copolymers

### DETAILED DESCRIPTION

The present inventors found that true block copolymers could be obtained when a sequential polymerisation technique was applied in the ring opening copolymerisation of two or more cyclic esters catalyzed by a compound of formula I as herein disclosed. Without willing to be strictly bound to it the present inventors believe that the catalyst of compound I is very selective in catalyzing the ring-opening polymerisation of cyclic esters. More in particular if was found that while the catalyst will catalyze the ring opening polymerisation reaction, it will leave ester functionalities already incorporated in the growing polymer chain substantially unaffected. In other words, the catalyst of compound I was found not to catalyze transesterification of the polymer. This is of particular importance when the polymerisation involves the ring opening polymerisation of large ring-size cyclic esters which lack a high ring strain and as such resemble the ester functionalities in the polymer chain.

Therefore, by employing the process of the present invention at least part of the aforementioned objectives are met.

The term chain length as used herein refers to the shortest number of atoms between two ester functionalities (O═)C—O—. Hence the “chain length” does not include any optional branches or side groups. For example, if R^{x} is (C₄H₈) the chain length is four. Similarly, if R^{x} is CH₂—C(CH₃)₂—CH₂—CH₂ the chain length is also four.

Organic group R^{x} of the first block in the block copolymer is a branched or straight hydrocarbon group optionally containing one or more heteroatoms provided that the atom neighboring the —O— is a carbon atom, i.e. not a heteroatom. R^{x} may contain one or more unsaturations, like —C═C—. Preferably R^{x} is a branched or straight hydrocarbon group, more preferably R^{x} is a branched or straight aliphatic group. R^{x} may be a saturated aliphatic group.

In view of the method according to the present invention, which is based on the ring opening polymerisation of cyclic esters, R^{x} may originate from the ring of a first cyclic ester having a ring size from 4-11 atoms, preferably from 4-8 atoms. Preferably the first cyclic ester is a lactone, which is a cyclic ester having a single ester group in the ring. Preferably the atoms forming the ring, other than the oxygen of the ester, are carbon atoms. Examples of the first cyclic ester include β-propiolactone, β-butyrolactone, 3-methyloxetan-2-one, γ-valerolactone, caprolactone, ε-caprolactone, ε-decalactone, 5,5-dimethyl-dihydro-furan-2-one, (S)-γ-hydroxymethyl-γ-butyrolactone, γ-octanoic lactone, γ-nonanoic lactone, δ-valerolactone, δ-hexalactone, δ-decalactone, δ-undecalactone, δ-dodecalactone, glycolide, lactide (L, D, meso), heptalactone, octalactone, nonalactone, decalactone. Particularly preferred first cyclic esters are ε-caprolactone, ε-decalactone, β-butyrolactone, glycolide, and lactide in view of their commercial availability and reactivity. Preferably the first cyclic ester has only one ester functionality in the ring.

In a specific embodiment and in view of the method R^{x} may originate from a cyclic ester containing two ester functionalities in the ring wherein the ester functionalities are linked with an R^{x} group. In such a specific embodiment, the ring size is from 6 to 22.

In the first block n₁ is at least 2, yet a skilled person will understand that n₁ will preferably be at least 20, preferably at least 100, more preferably at least 500, 1000, or even at least 5000, depending on the desired molecular weight and properties of the final block copolymer. As a practical upper limit n₁ may be 10000.

The organic group R^{y} of the second block in the block copolymer is a branched or straight hydrocarbon group optionally containing one or more heteroatoms provided that the atom neighboring the —O— is a carbon atom, i.e. not a heteroatom. R^{y} may contain one or more unsaturations, like —C═C—. Preferably R^{y} is a branched or straight hydrocarbon group, more preferably R^{y} is a branched or straight aliphatic group. R^{y} may be a saturated aliphatic group.

In view of the method according to the present invention, which is based on the ring opening polymerisation of cyclic esters R^{y} in the block copolymer may originate from the ring of a second cyclic ester having a ring size from 12-40 atoms. Preferably however the ring size of the second cyclic ester is from 12 to 24 atoms. Preferably the second cyclic ester is a lactone. Preferably the atoms forming the ring, other than the oxygen of the ester, are carbon atoms. The second cyclic ester may be for example 11-undecalactone, 12-dodecalactone, 13-tridecalactone, 14-tetradecalactone, 15-pentadecalactone (or ω-pentadecalactone), globalide, 16-hexadecalactone, ambrettolide, 17-heptadecalactone, 18-octadecalactone, 19-nonadecalactone. Particularly preferred second cyclic esters are pentadecalactone, 18-octadecalactone, 12-pentadecen-15-olide (known as globalide) and 7-hexadecen-16-olide (known as ambrettolide) in view of their commercial availability and/or ease of manufacture and good reactivity. Preferably the second cyclic ester has only one ester functionality in the ring.

In a specific embodiment and in view of the method R^{y} may originate from a cyclic ester containing two ester functionalities in the ring. In such embodiment the ester functionalities are linked with R^{y} groups. The ring size is then at least 24 and may be from 24 to 52.

In the second block n₂ is at least 2, yet a skilled person will understand that n₂ will preferably be at least 20, preferably at least 100, more preferably at least 500, 1000, or even at least 5000, depending on the desired molecular weight and properties of the final block copolymer. As a practical upper limit n₂ may be 10000.

In a particularly preferred embodiment the first cyclic ester is ε-caprolactone and the second cyclic ester is ω-pentadecalactone so that R^{x} is C₅H₁₀ and R^{y} is C₁₄H₂₈

The first and/or second cyclic esters, in particular where these are lactones, may be in any isomeric form and may further contain organic substituents on the ring that do not prevent the ring-opening polymerisation. Examples of such cyclic esters include 4-methyl caprolactone, 1,5-dioxepan-2-one (ether substituent at the 3 position), the lactone of ricinoleic acid (a 10-membered ring with a hexyl branched on the (co-1)-position) or the hydrogenated version of thereof, 13-hexyloxacyclotridecan-2-one (a macrocycle with a hexyl branch on the α-position), and the like.

It is further possible that the first and/or second cyclic ester comprise one or more unsaturations in the ring. Examples of such cyclic esters include 5-tetradecen-14-olide, 11-pentadecen-15-olide, 12-pentadecen-15-olide (also known as globalide), 7-hexadecen-16-olide (also known as ambrettolide), 9-hexadecen-16-olide.

The first and/or second cyclic ester may further have one or more heteroatoms in the ring, provided that such do not prevent the ring-opening polymerisation. Examples of such cyclic esters include 10-oxahexadecanolide, 11-oxahexadecanolide, 12-oxahexadecanolide, and 12-oxahexadecen-16-olide. Preferably however, the first and/or second cyclic esters do not contain heteroatoms in the ring.

The term ring-size as used herein refers to the number of atoms that form the ring in the cyclic ester. For example caprolactone has a seven membered ring, i.e. a ring size of seven. The ring of caprolactone consists of six carbon atoms and one oxygen atom. The ring size of the cyclic esters is also reflected in the chain length as defined for R^{x} and R^{y}. For example, for ε-caprolactone R^{x} will have a chain length of 5 atoms, corresponding to the C₅H₁₀ group in the ring. Hence a ring size of seven for a first cyclic ester corresponds to a chain length of five for R^{x}. The same principle applies to the second cyclic ester and the chain length of Ry. Said in another way, for cyclic esters having a single ester functionality in the ring, the chain length of R^{x} or R^{y} (as the case may be) corresponds to the ring size of the cyclic ester on which the first or second block is based minus two. Similarly the ring size of lactide, a cyclic ester containing two ester functionalities in the ring, is 6. The chain length of R^{x} is for lactide is 1.

The block copolymer according to the present invention may have any structure generally known for block copolymers and is preferably of the type selected from the group consisting of:

A-B di-block copolymer,

A-B-A or B-A-B tri-block copolymer,

(A-B)ₙ block copolymer wherein n is an integer and from 2-20,

(B-A)ₙ block copolymer wherein n is an integer and from 2-20,

A(B-A)ₙ block copolymer wherein n is an integer and from 2 to 20,

B(A-B)ₙ block copolymer wherein n is an integer and from 2 to 20,

wherein A represents a first block and B represents a second block.

In an embodiment where a block copolymer contains two or more A blocks these A blocks may be the same or different in length, i.e. may have the same or different molecular weight, depending on the conditions of the process to manufacture the block copolymer.

Likewise in an embodiment where a block copolymer contains two or more B blocks these B blocks may be the same or different in length, i.e. may have the same or different molecular weight depending on the conditions of the process to manufacture the block copolymer.

The block copolymer may be a linear block copolymer, a star type block copolymer, such as a Y-type branched block copolymer, an H-type branched block copolymer, and a comb type, or brush type, block copolymer.

A Y-type branched block copolymer is a block copolymer that has three branches connected to one another at a central point. Such type of copolymer is a species of the more general term star type block copolymers.

An H-type branched block copolymer is a block copolymer that has four branches connected to one another from a central linking group (or bridge). Such type of copolymer is a species of the more general term star type block copolymers. The bridge may be a short hydrocarbon chain, for example having a chain length of from two to six carbon atoms, from which the four branches extend.

A comb or brush type block copolymer is a block copolymer that has a linear molecular chain as a backbone (the base of the comb or brush) from which a multitude of branches (the teeth of the comb or brush) extend.

A star type block copolymer is a block copolymer that has a central point from which a multitude of branches extend.

At least one of the branches in the aforementioned types of block copolymers contains at least one first block and at least one second block. In an embodiment each branch contains at least one first block and at least one second block.

The present inventors believe this flexibility in tuning the type of block copolymer is a strength of the method according to the present invention. The block copolymer type may be tuned by selecting the appropriate initiator. For example if pentaerythritol is selected as the initiator then a star-type block copolymer may be formed having four branches, each branch being a block copolymer as herein defined.

The block copolymer may comprise a third block or further blocks of general structure

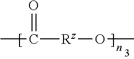

wherein R^{z} is an organic group having a chain length of from 1-38 atoms and n₃ is at least 2. Similar to n₁ and n₂, n₃ is at least 2, yet a skilled person will understand that n₃ will be at least 20, preferably at least 100, more preferably at least 500, 1000, or even at least 5000, depending on the desired molecular weight and properties of the final block copolymer. As a practical upper limit n₃ may be 10000.

Organic group R^{z} of the third (or further) block in the block copolymer is a branched or straight hydrocarbon group optionally containing one or more heteroatoms provided that the atom neighboring the —O— is a carbon atom, i.e. not a heteroatom. R^{z} may contain one or more unsaturations (—C═C—). Preferably R^{z} is a branched or straight hydrocarbon group, more preferably R² is a branched or straight aliphatic group. R^{z} may be a saturated aliphatic group.

In view of the method according to the present invention, which is based on the ring opening polymerisation of cyclic esters R^{z} in the block copolymer may originate from the ring of a third cyclic ester. Preferably the third or any further blocks are of a third or further polymer obtained by the ring opening polymerisation of a third or further cyclic ester having a ring size of from 4-40 atoms, such as the cyclic esters disclosed herein. Preferably the third or further cyclic ester is a lactone.

In a specific embodiment and in view of the method R^{y} may originate from a cyclic ester containing two ester functionalities in the ring wherein the ester functionalities are linked with an R^{y} group. In such a specific embodiment, the ring size may be from 6 to 52.

In an embodiment where the block copolymer contains a third or further blocks the skilled person will understand that the preferred block structures will then include C or further blocks in all possible combinations including but not limited to A-B-C, A-C-B, C-A-B, B-A-C, B-C-A, C-B-A and comparable repeating structures as disclosed herein for the A-B type of block copolymers.

The block copolymer may have any desired molecular weight, from relatively low if a waxy material is desired or to relatively high values so as to obtain the desired mechanical properties or melt viscosity. Preferably the number average molecular weight (Mₙ) is at least 2000 gram/mol with a practical upper limit of for example 150000 g/mol. More preferable Mₙ is from 30000 to 100000 g/mol or 50000 to 80000 gram/mol.

An important aspect of the block copolymers is that they exhibit a relatively low polydispersity index, which preferably is at most 3. Polydispersity index, or PDI, as defined herein means the ratio of the weight average molecular weight and the number average molecular weight (M_{w}/Mₙ). More preferably the PDI is from 1-3 or from 1-2. The low polydispersity is obtained as a result of the process which process reduces any transesterification to a minimum.

The present inventors have found that the catalyst compound of general formula I as herein disclosed reduces any transesterification of the polymer chain to a minimum. This minimized tendency for transesterification is supported by ¹³C NMR spectra and the present inventors have observed that at least 80%, preferably at least 90%, more preferably at least 95% of the total signal related to an α-methyl carbon of the first cyclic ester is present in a single peak in a ¹³C NMR spectrum of the block copolymer and at least 80% preferably at least 90%, more preferably at least 95% of the total signal related to an α-methyl carbon of the second cyclic ester is present in a single peak in said ¹³C NMR spectrum. In an embodiment wherein a third cyclic ester is copolymerized as a block, such block will have similar properties.

The composition of the block copolymer is not particularly limited and may be selected so as to fit the intended application. In general it is however preferred that the amount of first block in the block copolymer is from 5-95 wt % and the amount of second block in the block copolymer is from 95-5 wt % based on the combined weight of the first and second blocks in the block copolymer.

In a preferred embodiment the block copolymer consists of one or more first blocks as herein defined and one or more second blocks as herein defined.

The block copolymer preferably is a block co-polyester.

The block copolymer may be prepared by a method comprising providing a first cyclic ester having a ring size of from 12-40 atoms and a second cyclic ester having a ring size of from 4-11 atoms and subjecting the first and second cyclic ester to ring-opening copolymerisation using as catalyst a compound of formula I

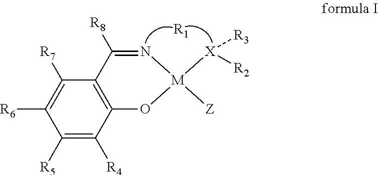

wherein

M is a metal and selected from the group consisting of group 2 metals and group 12 metals

Z is selected from the group consisting of hydrogen, borohydrides, aluminium hydrides, carbyls, silyls, hydroxides, alkoxides, aryloxides, carboxylates, thiocarboxylates, dithiocarboxylates, carbonates, carbamates, guanidates, amides, thiolates, phosphides, hydrazonate, imide, cyanide, cyanate, thiocyanate, azide, nitro, siloxides and halides;

X is selected from the group consisting of O, N, S, and P

R¹ is an organic linking moiety and has a chain length of at least one, preferably at least two atoms,

R² is an organic moiety selected from the group consisting of hydrogen, C₁₋₁₀ alkyl, silyl, C₁₋₆ alkoxy, C₃₋₈ cycloalkyl, C₃₋₈ cycloalkoxy, aryl, aryloxy, C₁₋₁₀ amine, C₁₋₁₀ nitro, C₁₋₁₀ cyano a halide (F, Cl, Br, I), and a 5- or 6-membered heterocycle containing from 1 to 4 heteroatoms selected from oxygen, sulfur, nitrogen, and phosphorous.

R³ is an optional organic moiety and may be the same or different as R²

R⁴, R⁵, R⁶, R⁷ are organic moieties, may be the same or different and selected from the group consisting of hydrogen, C₁₋₁₀ alkyl, silyl, C₁₋₆ alkoxy, C₃₋₈ cycloalkyl, C₃₋₈ cycloalkoxy, aryl, aryloxy, _{C1-10} amine, C₁₋₁₀ nitro, C₁₋₁₀ cyano a halide (F, Cl, Br, I), and a 5- or 6-membered heterocycle containing from 1 to 4 heteroatoms selected from oxygen, sulfur, nitrogen, and phosphorous.

R⁸ is an organic moiety selected from the group consisting of hydrogen, C₁₋₁₀ alkyl, silyl, C₁₋₆ alkoxy, C₃₋₈ cycloalkyl, C₃₋₈ cycloalkoxy, aryl, aryloxy, _{C1-10} amine, C₁₋₁₀ nitro, C₁₋₁₀ cyano a halide (F, Cl, Br, I), and a 5- or 6-membered heterocycle containing from 1 to 4 heteroatoms selected from oxygen, sulfur, nitrogen, and phosphorous,

and wherein the copolymerisation is carried out by sequential polymerisation of the first and second cyclic ester.

The term “sequential polymerisation” as used herein should be understood to mean the sequential ring opening polymerization of the cyclic esters. In this polymerisation technique one cyclic ester is polymerized at a time and only after a first cyclic ester has been substantially converted to polymer then a second cyclic ester is added to the reaction. A sequential polymerisation technique is therefore very different from a copolymerisation technique wherein both cyclic esters are added or are otherwise present during the reaction at the same time, such a technique possibly being referred to as a “1-pot” or “single feed” technique. The method can be carried out by ring opening polymerisation of the first cyclic ester followed by ring opening polymerisation of the second cyclic ester, or by ring opening polymerisation of the second cyclic ester followed by ring opening polymerisation of the first cyclic ester. With respect to group Z:

the borohydride may be BH₄—ₓRₓ wherein x is an integer from 0-3 and R is carbyl or alkoxide,

the aluminium hydrides may be AlH₄₋ₓRₓ, wherein x is an integer from 0-3, and R is carbyl or alkoxide,

the carbyl may be any hydrocarbon, —CR₃, —Ar (aryl), —CR═CR₂, —C≡CR, wherein R is hydrogen, optionally substituted alkyl, optionally substituted aryl,

the silyl may be —SiR₃, wherein R is hydrogen, optionally substituted alkyl, optionally substituted aryl,

the alkoxide may be —OR, wherein R is optionally substituted alkyl,

the carboxylate may be —OC(═O)R, wherein R is hydrogen, optionally substituted alkyl, optionally substituted aryl),

the thiocarboxylate may be —SC(═O)R, wherein R is hydrogen, optionally substituted alkyl, optionally substituted aryl,

the dithiocarboxylate may be —SC(═S)R, wherein R is hydrogen, optionally substituted alkyl, optionally substituted aryl,

the guanidinate may be (—N═C(R^{a})N(R^{b})R^{c} or N(R^{b})C(R^{a})═NR^{c}, wherein R^{a}, R^{b}, R^{c} is hydrogen, optionally substituted alkyl, optionally substituted aryl,

the carbonate may be —OC(═O)OR, wherein R is optionally substituted alkyl, optionally substituted aryl,

the carbamate may be —OC(═O)NR₂, wherein R is optionally substituted alkyl, optionally substituted aryl,

the amide may be —NR₂, wherein R is hydrogen, optionally substituted alkyl, optionally substituted aryl,

the thiolate may be —SR, wherein R is hydrogen, optionally substituted alkyl, optionally substituted aryl,

the phosphide may be —PR₂, wherein R is hydrogen, optionally substituted alkyl, optionally substituted aryl,

the hydrazonate may be (—N(R^{a})N═C(R^{b})R^{c}, where R^{a}, R^{b}, R^{c} is hydrogen, optionally substituted alkyl, optionally substituted aryl,

the imide may be (—N═C(R^{a})R^{b}, where R^{a}, R^{b} is hydrogen, optionally substituted alkyl, optionally substituted aryl.

The term “carbyl” as used herein is meant to refer to all types of hydrocarbons including alkyl, aryl, vinyl, and acetylene.

Substituent Z can inter alia be a borohydride or an aluminium hydride. Borohydrides (e.g. BH₄) and aluminium hydrides (e.g. AlH₄) are anionic species that bind via the hydrides. This may be illustrated as M(μ-H)₂AH₂ (M=as defined above, A=B or Al).

Preferably Z is a carbyl group having 1-4 carbon atoms, such as ethyl or methyl, propyl and butyl or Z is pentyl, hexyl, heptyl, n-octyl, or Z is an alkoxide group containing 1-20 carbon atoms, such as methoxide, ethoxide, or benzyloxide.

If Z is a carbyl group having 1-4 carbon atoms then in use when activating the catalyst with for example an alcohol, the respective organic molecule is released from the reaction mixture in gaseous form leaving no residues. For example, if Z is ethyl, then upon activation of the catalyst with an alcohol, ethane is released and catalytically active metal alkoxide is formed.

The metal M is preferably selected from the group consisting of calcium, zinc, and magnesium and is preferably calcium or zinc. The present inventors found that catalysts based on these metals allow high molecular weight polymers to be obtained and can be prepared relatively easily. In addition to that these metals are biocompatible and may be applied in polymers that need to be FDA approved.

R¹ of formula I is preferably a straight or branched aliphatic chain, or cyclic or aromatic moiety, that contains 2 to 30 carbon atoms, optionally containing 1 to 10 heteroatoms selected from N, O, F, CI and Br.

In a preferred embodiment of the method according to the present invention:

X is N

R⁵, R⁷ and R⁸ are hydrogen and/or

R⁴ and R⁶ are independently selected from hydrogen, methyl, ethyl, propyl, isopropyl, n-butyl, i-butyl, s-butyl, t-butyl, n-pentyl, i-pentyl, neopentyl, n-hexyl, 2,2 dimethylbutane, 2-methylpentane, 3-methylpentane, 2,3 dimethylbutane, cyclohexane, adamantyl, methoxide, ethoxide, (n-/t-)butoxide, aryloxide and halides.

In a further preferred embodiment of the method of the present invention:

R¹ is a —[CH₂—CH₂]— linking moiety R² and R³ are hydrogen and/or

R⁵, R⁷ and R⁸ are hydrogen and/or

R⁴ and R⁶ are tert-butyl and/or

X is N and/or

Z is ethyl or N(Si—CH₃)₂.

In a specific embodiment the catalyst in the method is selected from Catalyst 1 and Catalyst 2.

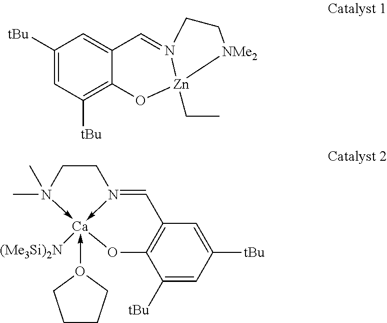

The mechanism and initiation of ring-opening polymerization is well known to the skilled person and is for instance described in “Handbook of Ring Opening Polymerization, 2009, Eds. Philippe Dubois, Olivier Coulembier, Jean-Marie Raquez, Wiley VCH, ISBN: 978 3 527 31953 4”.

An important aspect of the catalyst is that these catalysts show living/well-controlled behavior allowing the formation of block-copolymers. Moreover, these catalysts are stable in the presence of an excess of protic chain transfer agents, which creates an immortal catalyst system allowing the production of multiple polymer chains per active site without loss of activity and while remaining perfect control over the molecular weight, PDI and polymer microstructure (random and block copolymers) as well as topology (linear, star-shaped (co-) polymers).

In the method the molar ratio between the amount of cyclic ester and the catalyst is preferably in the range of 20:1-1000:1, preferably in the range of 40:1-750:1, more preferably in the range of 50:1-500:1. The ratio cyclic ester to catalyst determines the molecular weight of the polymer.

Optionally the catalyst used in the method may be applied in combination with an initiator, preferably in about equimolar amount. Suitable initiators for the method include protic reagents such as alcohols, water, carboxylic acids, and amines. Such initiators are well known to the person skilled in the art and examples thereof can, for instance, be found in Clark et al., Chem. Commun. 2010, 46, 273-275 and references cited therein, which document is herewith incorporated by reference. The use of multifunctional initiators (or chain transfer agents) is for example disclosed in Dong et al., Macromolecules 2001, 34, 4691 or Dong et al., Polymer 2001, 42, 6891 or Kumar et al, Macromolecules 2002, 35, 6835, or Zhao et al., Chem. Mater. 2003, 15, 2836 or Carnahan et al., J. Am. Chem. Soc. 2001, 123, 2905. In an embodiment where the ring-opening polymerization is performed in the presence of an initiator, the molar ratio between initiator and catalyst is about 1:1, unless the reagent used as initiator is also used as chain transfer agent.

If the initiator is also used as chain transfer agent then the molar ratio between the cyclic esters and the initiator can be used as a tool for tuning the molecular weight of the polymer that is prepared according to the inventive method. To that extent the present inventors found that the molecular weight of the polymer increases almost linearly with an increasing cyclic ester to initiator ratio.

In an embodiment where the initiator is used as a chain transfer agent, then the initiator is added in excess with respect to the catalyst to produce more than one chain per active site. The amount of applied catalyst can be reduced in the presence of a chain transfer agent due to an increase in catalyst efficiency. If present, the molar amount of chain transfer agent will typically be in the range of 1-1000 times the molar amount of catalyst, preferably in the range of 10-100, more preferably 10-50 times the molar amount of catalyst. In this embodiment the monomer to catalyst ratio may be more than 1000:1. The molar ratio of cyclic ester to catalyst in such embodiment can reach relatively high values, for example up to 1000000.

The ring-opening polymerization reaction is preferably performed in an inert atmosphere, such as in a nitrogen atmosphere for the reason that the catalysts perform better under inert atmosphere and preferably in the absence of (significant amounts of) water.

If desired, the ring-opening polymerization of the invention can be performed in the presence of a solvent, such as aliphatic or aromatic hydrocarbons (e.g. heptane, toluene), halogenated aliphatic or aromatic hydrocarbons (e.g. dichloromethane, bromobenzene), ethers (e.g. diethyl ether). The solvent may be used to dissolve the cyclic esters and/or to increase the polymerization kinetics and selectivity. The ring-opening polymerization may however also be carried out in bulk monomer.

The molecular weight of the copolymer prepared by the process of the invention may vary within wide limits and can be tuned to meet specific properties of the polymer. The molecular weight may be tuned by selecting the molar ratio between the cyclic esters and the catalyst, the types of first and second cyclic ester (s) that are employed in the reaction and, if applicable, the amount and type of chain transfer agent (or initiator).

Advantageously, the method is performed at relatively high process temperatures, at which enzymes used for enzymatic ring-opening polymerization of lactones would normally degrade. Typically, the process of the invention can be performed at a temperature in the range of from 70-180° C., such as in the range of from 80-175° C., or in the range of from 90-150° C.

Since the amount of catalyst used in the process of the invention is relatively low, there is no direct need for separating the catalyst from the copolymer product once prepared. However, should there be a need for separating the catalyst from the copolymer for whatever reason then this can be done for instance by precipitation of the polymer in a suitable solvent.

The copolymers obtained with the process described herein can be used in a wide variety of applications depending on their respective properties, such as molecular weight, polydispersity index, type, and respective amounts of first and second blocks etc.

For example, the copolymers may be used in biomedical applications such as bone scaffolding, bone screws, or suture wire. In this respect it is an advantage that the biodegradability of the copolymers can be tuned by the choice of type, amount, and block length of the monomers. For example it is known that (co)polymers from lactones having relatively low ring size are more biodegradable than lactones with a high ring size. So, by tuning the composition (i.e. choice and amount of first and second lactones) of the copolymer the desired biodegradability can be obtained. The copolymers may further be used in polymer compositions further comprising other polymer materials such as for example polyesters, polycarbonates, polyamides and polyolefins. An important aspect of the copolymers is that they consist of blocks with relatively high amount of ester functionalities and blocks with relatively low amount of ester functionalities. The polarity of these blocks differs so that it can be said that the copolymer consists of blocks with relatively high polarity and blocks with relatively low polarity. This property potentially allows the copolymers to be used as a compatibilizer in polymer systems containing both polar as a-polar materials or in composite systems.

The block copolymer is preferably a block co-polyester.

The invention will now be further illustrated by means of the following Examples, and the Figures.

### Examples

All solvents and reagents were purchased from commercial sources unless stated otherwise. p-Xylene (99.9° A)) was dried over sodium and fractionally distilled under nitrogen and degassed prior to use. Hexadecanol, pentadecalactone, ε-decalactone, ambrettolide, ε-caprolactone, and β-butyrolactone were freshly distilled from CaH₂ under nitrogen prior to use. Toluene was passed through purification columns and degassed before use.

¹H NMR and ¹³C NMR spectra were recorded at room temperature in CDCl₃ using a Varian Mercury Vx spectrometer operating at frequencies of 400 MHz and 100.62 MHz for ¹H and ¹³C, respectively. For ¹H NMR experiments, the spectral width was 6402.0 Hz, acquisition time 1.998 s and the number of recorded scans equal to 64. ¹³C NMR spectra were recorded with a spectral width of 24154.6 Hz, an acquisition time of 1.300 s, and 256 scans. Chemical shifts are reported in ppm vs. tetramethylsilane (TMS) and were determined by reference to TMS.

High Temperature Size Exclusion Chromatography (HT-SEC) was performed at 160° C. using a Polymer Laboratories PLXT-20 Rapid GPC Polymer Analysis System (refractive index detector and viscosity detector) with 3 PLgel Olexis (300×7.5 mm, Polymer Laboratories) columns in series. 1,2,4-Trichlorobenzene was used as eluent at a flow rate of 1 mL·min⁻¹. The molecular weights were calculated with respect to polyethylene standards (Polymer Laboratories). A Polymer Laboratories PL XT-220 robotic sample handling system was used as autosampler.

MALDI-ToF-MS analysis was performed on a Voyager DE-STR from Applied Biosystems equipped with a 337 nm nitrogen laser. An accelerating voltage of 25 kV was applied. Mass spectra of 1000 shots were accumulated. The polymer samples were dissolved in CHCl₃ at a concentration of 1 mg·mL⁻¹. The cationization agent used was potassium trifluoroacetate (Fluka, >99%) dissolved in THF at a concentration of 5 mg mL⁻¹. The matrix used was trans-2-[3-(4-tert-butylphenyl)-2-methyl-2-propenylidene]-malononitrile (DCTB) (Fluka) and was dissolved in THF at a concentration of 40 mg mL⁻¹. Solutions of matrix, salt, and polymer were mixed in a volume ratio of 4:1:4, respectively. The mixed solution was hand-spotted on a stainless steel MALDI target and left to dry. The spectra were recorded in the reflectron mode. All MALDI-ToF-MS spectra were recorded from the crude products.

The thermal stability of the polymers was determined by thermo-gravimetric analysis (TGA) with a TGA Q500 apparatus from TA Instruments. The samples were heated from 30° C. to 600° C. at a heating rate of 10° C./min under a nitrogen flow of 60 mL·min⁻¹.

Melting temperatures (Tₘ) were measured by differential scanning calorimetry (DSC) using a DSC Q100 from TA Instruments. The measurements were carried out at a heating and cooling rate of 10° C.·min⁻¹ from −60° C. to 130° C. The transitions were deduced from the second heating and cooling curves. First and second runs were recorded after cooling down to ca. 20° C. The melting temperatures reported correspond to the melting peaks in the second runs.

### Catalyst Preparation

Catalysts 1 and 2 were prepared using procedures known in the art. Examples of such methods can be found in Cameron et al., J. Chem. Soc., Dalton Trans. 2002, 3, 415 and/or WO 2004/081020 and/or Troesch et al., Anorg. Allg. Chem 2004, 630, 2031-2034 and/or Chamberlain et al., J. Am. Chem. Soc. 2001, 123, 3229 and/or Colesand et al., Eur. J. Inorg. Chem. 2004, 2662.

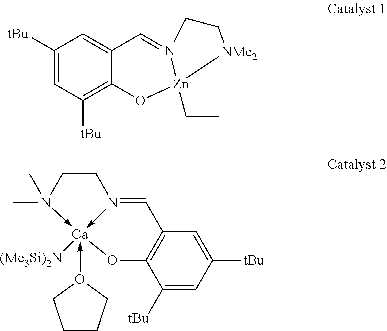

### Experiment 1: Sequential Feed Co-Polymerisation of PDL and CL

PDL monomer and toluene were transferred into an ampule under inert nitrogen atmosphere in a glove box. Catalyst 1 and an equimolar amount (with respect to the catalyst) of BnOH was added to the mixture and the vial was then capped and placed in an oil bath at 100° C. for a predetermined reaction time. At the end of the reaction period, an aliquot was taken for analysis and the calculated ratio of CL monomer was added, the sealed vial was then placed for an additional predetermined time at 100° C. In Experiment one the CL/PDL molar ratio was 2:1. At the end, an aliquot was removed and dissolved in CDCl₃ for NMR and the mixture was quenched by acidic methanol and the precipitated polymer was filtered, washed with methanol several times and dried under vacuum for 24 h before characterization.

### Experiment 2: Sequential Feed Co-Polymerisation of PDL and CL

Experiment 2 was carried out in a similar manner as Experiment 1, but with Catalyst 2 as the catalyst.

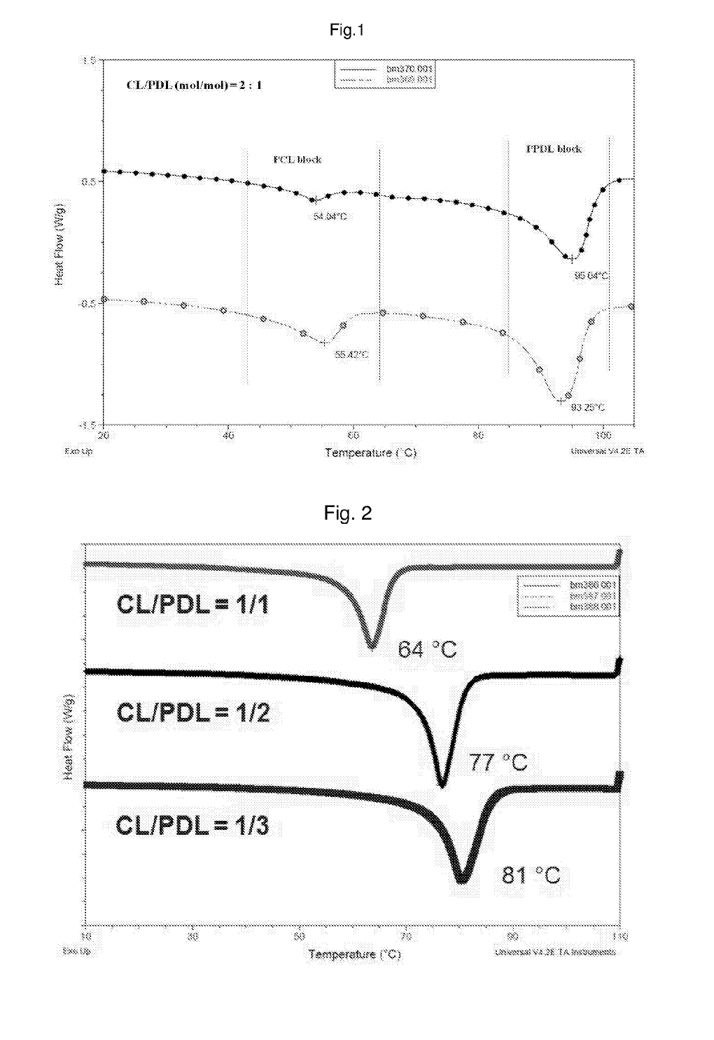

DSC plots of the polymers prepared in Experiments 1 and 2 are shown in FIG. 1. The upper curve corresponds to Experiment 1 and the lower curve corresponds to Experiment 2. Both DSC curves show two endothermic parts with two distinct melting temperatures corresponding to block polycaprolactone (PCL) with a melting temperature of about 55° C. and PPDL with a melting temperature of about 94° C. The present inventors found that the (sequential) copolymerization of CL and PDL catalyzed by Catalyst 1 or Catalyst 2 occurs without transesterification side reactions, since after 18 hours at 100° C., the blocky structure was still maintained and no redistribution of the monomers in the copolymer backbone had taken place. To confirm this finding, a mixture of block poly(PDL-block-CL) copolymer produced using Catalyst 1 and a transesterification catalyst (TBD/BnOH (1% w/w)) was stirred for 18 hours and samples were taken at set time intervals (2, 7 and 18 h) and analyzed by DSC. The blocky copolymer structure indeed gradually transformed into a completely random copolymer with a single melting point between the melting points of PCL and PPDL.

The block character of the poly(PDL-block-CL) copolymer obtained by the sequential feed is further evidenced by the presence of two overlapping triplets in ¹H NMR spectrum, each of said triplets corresponding to the protons of α-methylene groups of CL and PDL units in the PCL and PPDL blocks respectively.

### Comparative Experiment 1: One Pot Co-Polymerisation of CL and PDL

In a glove box, PDL, CL, Catalyst 1 and an equimolar amount (to catalyst) of BnOH were placed simultaneously in a small glass crimp cap vial. The vial was capped, removed from the glove box, and heated at 100° C. for the given time (1 to 18 h). For all reactions, an aliquot of crude polymer was removed for the determination of copolymerization conversion. The copolymer was then precipitated in THF, dried under vacuum for 18 h, and characterized by size-exclusion chromatography (SEC), differential scanning calorimetry (DSC), and ¹H, ¹³C nuclear magnetic resonance spectroscopy (NMR).

FIG. 2 shows a DSC plot of three polymers prepared with three different monomer molar ratio's CL/PDL. The DSC plots only show a single melting peak indicative for the formation of random copolymers rather than block copolymers. The random character of the poly(PDL-co-CL) copolymer obtained by one-pot synthesis is evidenced by the presence of only one triplet corresponding to the protons of α-methylene groups of both CL and PDL units in the ¹H NMR spectrum.

Comparative Experiment 2: Co-Polymer of PDL and ε-Decalactone (eDL)

Contrary to expectations of the present inventors it was found that PDL and eDL when copolymerized using a one-pot synthesis yielded blocky copolymers. Without willing to be strictly bound to it, the present inventors attribute this finding to the steric hindrance that the butyl branch of eDL imposes on the insertion of PDL units during the polymerisation. The steric hindrance and the conformation of the eDL and PDL has the effect of difference in reactivity of the two monomers causing favorable polymerisation of eDL. Experiments were carried out using Catalyst 1 using similar experimental conditions as in Comparative Experiment 1. The reaction was carried out at 100° C. and the combined concentration (for solution reaction) of PDL and eDI was 4.16 mold.

Table 1 below summarises the experiments. [M] designates molar equivalents of monomer, i.e. cyclic ester, [Cat] refers designates molar equivalents of catalyst, [BnOH] designates molar equivalents of BnOH, [PDL] designates molar equivalents of PDL, [eDL] designates molar equivalents of eDL. Tr means reaction time. The conversion was determined from ¹H NMR spectra and expressed in percentage. The number average and weight average molecular weight was determined using HT-SEC in TCB against polyethylene standards. The PDI (polydispersity index) is the ratio of M_{w}/Mₙ. Experiments for samples #1-5 were carried out in bulk at 100° C., whereas experiments for samples #6-16 were carried out in solvent at a temperature of 100° C.

TABLE 1

| | mol ratio | | | | | |
|---|---|---|---|---|---|---|
| | [M]/[Cat]/ | mol ratio | Tr | Conversion | Mₙ | |
| # | [BnOH] | [PDL]/[eDL] | [h] | [PDL]/[eDL] | [kg/mol] | PDI |
| 1 | 500/1/0.5 | 1/0 | 5 | 54/— | 73.0 | 2.3 |
| 2 | 500/1/0.5 | 0.7/0.3 | 14 | 25/100 | 15.5 | 1.9 |
| 3 | 500/1/0.5 | 1/1/ | 24 | 64/100 | 21.8 | 2.3 |
| 4 | 500/1/0.5 | 0.3/0.7 | 24 | 44/100 | 18.6 | 1.9 |
| 5 | 500/1/0.5 | 0/1 | 3 | —/100 | 13.8 | 1.3 |
| 6 | 100/1/1 | 1/1 | 1 | 18/88 | 6.6 | 1.22 |
| 7 | 100/1/1 | 1/1 | 2 | 24/100 | 7.8 | 1.55 |
| 8 | 100/1/1 | 1/1 | 3 | 45/100 | 10.9 | 1.84 |
| 9 | 100/1/1 | 1/1 | 5 | 78/100 | 14.5 | 2.08 |
| 10 | 100/1/1 | 1/1 | 8 | 81/100 | 13.4 | 2.00 |
| 11 | 100/1/1 | 1/1 | 14 | 94/100 | 15.8 | 2.07 |
| 12 | 100/1/1 | 1/1 | 24 | 100/100 | 15.2 | 2.02 |
| 13 | 100/1/1 | 1/0 | 3.5 | 95/— | 13.5 | 2.19 |
| 14 | 100/1/1 | 0/1 | 3.5 | —/100 | 3.6 | 1.13 |
| 15 | 100/1/1 | 0.7/0.3 | 3.5 | 44/100 | 6.6 | 1.70 |
| 16 | 100/1/1 | 0.3/0.7 | 3.5 | 36/100 | 5.6 | 1.79 |

From samples #6 to #13 it can be observed that eDL is completely converted within about 2 hours, whereas at that point PDL has only converted to 24%. Since the catalysts reduce any transesterification to a minimum, the obtained polymer is regarded as a blocky co-polymer. The blocky structure was confirmed with other analytical techniques such as DSC, NMR, and MALDI-ToF-MS

Interestingly the homo-polymerisation of PDL reaches a conversion of about 95% after 3.5 hours, whereas during copolymerisation with eDL this conversion is only reached after about 14 hours. These results support the findings of the present inventors as set out above for this Comparative Experiment 2.

Experiment 5: Co-Polymer of PDL and ε-Decalactone (eDL)

PDL and eDL where copolymerized in bulk at 100° C. using a one-pot synthesis. The reaction was carried out at 100° C., the ratio of Catalyst 2 to BnOH was 1, the amount of eDI was 0.354 g, the amount of PDL was 0.500 g, the amount of Catalyst 2 0.0239 g. Table 2 below summarises the experiments:

TABLE 2

| | | | | Conv. | Conv. | | |
|---|---|---|---|---|---|---|---|
| | Time | PDL | eDL | PDL | eDL | M_{n, exp} | |
| # | (h) | (mol %) | (mol %) | (%) | (%) | (kg/mol) | PDI |
| 1 | 1 | 100 | 0 | 91 | — | 9.8 | 2.3 |
| 2 | 2 | 100 | 0 | 94 | — | 10 | 2.1 |
| 3 | 3 | 100 | 0 | 97 | — | 9.9 | 2.2 |
| 4 | 4 | 100 | 0 | 98 | — | 9.9 | 2.2 |
| 5 | 5 | 100 | 0 | 99 | — | 10.2 | 2.2 |
| 6 | 24 | 100 | 0 | 99 | — | 9.3 | 2.3 |
| 7 | 1 | 50 | 50 | 19 | 100 | 3.1 | 1.7 |
| 8 | 2 | 50 | 50 | 64 | 100 | 4.2 | 2.0 |
| 9 | 3 | 50 | 50 | 67 | 100 | 4.6 | 2.1 |
| 10 | 4 | 50 | 50 | 93 | 100 | 6.1 | 2.0 |
| 11 | 5 | 50 | 50 | 93 | 100 | 6.2 | 2.1 |

Samples #1 to #6 show homo-polymerisation of PDL. The conversion already reaches a high level after one hour (91%). Samples #2-#6 shows that PDL conversion gradually increases to nearly 100% and that molecular weight and polydispersity remain at a more or less stable level.

In summary, a block copolymer comprises a first block of general structure

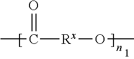

and a second block of general structure

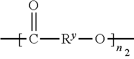

wherein

R^{x} is an organic group having a chain length of from 1-9 atoms;

R^{y} is an organic group having a chain length of from 10-38 atoms;

n₁ is at least 2; and

n₂ is at least 2;

optionally wherein one or more of the following conditions apply: the copolymer is of the type selected from the group consisting of an A-B di-block copolymer, A-B-A or B-A-B tri-block copolymer, (A-B)ₙ block copolymer wherein n is an integer and from 2-20, (B-A)ₙ block copolymer wherein n is an integer and from 2-20, (B-A)ₙ block copolymer wherein n is an integer and from 2 to 20, and B(A-B)ₙ block copolymer wherein n is an integer and from 2 to 20, wherein A represents a first block and B represents a second block; the block copolymer is a linear block copolymer, a star type block copolymer or a comb-type block copolymer; the block copolymer further comprises a third block of general structure

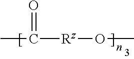

wherein R^{z} is an organic group having a chain length of from 1-38 atoms; and N₃ is at least 2; the block copolymer has a number average molecular weight Mₙ of at least 2000 gram/mole, as determined with High Temperature Size exclusion Chromatography performed at 160° C. using 1,2,4-trichlorobenzene as eluent at a flow rate of 1 mL/min and calculated with respect to polyethylene standards; the block copolymer has a polydispersity index, defined as Mw/Mn, of at most 3, preferably from 1-3, more preferably from 1-2; the first block is obtainable by the ring opening polymerisation of a first cyclic ester having a ring size of from 4-11 atoms and wherein the second block is obtainable by the ring opening polymerisation of a second cyclic ester having a ring size of from 12-40 atoms and wherein, if applicable, the third block is obtainable by the ring opening polymerisation of a third cyclic ester having a ring size of from 4-40 atoms, optionally wherein the first and/or the second and/or, if applicable, the third cyclic ester is a lactone, further optionally wherein at least 80% of the total signal related to an α-methyl carbon of the first cyclic ester is present in a single peak in a ¹³C NMR spectrum of the block copolymer and at least 80% of the total signal related to an α-methyl carbon of the second cyclic ester is present in a single peak in said ¹³C NMR spectrum and, if applicable, at least 80% of the total signal related to an α-methyl carbon of the third cyclic ester is present in a single peak in said ¹³C NMR spectrum.

In another embodiment, a method for preparing the block copolymer as described above comprises providing a first cyclic ester having a ring size of from 12-40 atoms and a second cyclic ester having a ring size of from 4-11 atoms and subjecting the first and second cyclic ester to ring-opening copolymerisation using as catalyst a compound of formula I

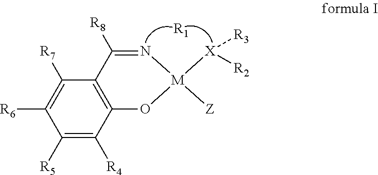

wherein

M is a metal and selected from the group consisting of group 2 metals and group 12 metals, preferably wherein metal M is selected from the group consisting of calcium, zinc, and magnesium and is preferably calcium or zinc;

Z is selected from the group consisting of hydrogen, borohydrides, aluminium hydrides, carbyls, silyls, hydroxides, alkoxides, aryloxides, carboxylates, thiocarboxylates, dithiocarboxylates, carbonates, carbamates, guanidates, amides, thiolates, phosphides, hydrazonate, imide, cyanide, cyanate, thiocyanate, azide, nitro, siloxides and halides;

X is selected from the group consisting of O, N, S, and P, preferably X is N;

R¹ is an organic linking moiety and has a chain length of at least one, preferably at least two atoms, preferably wherein R₁ is a straight or branched aliphatic chain, or cyclic or aromatic moiety, that contains 2 to 30 carbon atoms, optionally containing 1 to 10 heteroatoms selected from N, O, F, CI and Br;

R² is an organic moiety selected from the group consisting of hydrogen, C₁₋₁₀ alkyl, silyl, C₁₋₆ alkoxy, C₃₋₈ cycloalkyl, C₃₋₈ cycloalkoxy, aryl, aryloxy, _{C1-10} amine, C₁₋₁₀ nitro, C₁₋₁₀ cyano a halide (F, Cl, Br, I), and a 5- or 6 membered heterocycle containing from 1 to 4 heteroatoms selected from oxygen, sulfur, nitrogen, and phosphorous;

R³ is an optional organic moiety and may be the same or different as R²;

R⁴, R⁵, R⁶, R⁷ are organic moieties, may be the same or different and selected from the group consisting of hydrogen, C₁₋₁₀ alkyl, silyl, C₁₋₆ alkoxy, C₃₋₈ cycloalkyl, C₃₋₈ cycloalkoxy, aryl, aryloxy, _{C1-10} amine, C₁₋₁₀ nitro, C₁₋₁₀ cyano a halide (F, Cl, Br, I), and a 5- or 6 membered heterocycle containing from 1 to 4 heteroatoms selected from oxygen, sulfur, nitrogen, and phosphorous;

R⁸ is an organic moiety selected from the group consisting of hydrogen, C₁₋₁₀ alkyl, silyl, C₁₋₆ alkoxy, C₃₋₈ cycloalkyl, C₃₋₈ cycloalkoxy, aryl, aryloxy, _{C1-10} amine, C₁₋₁₀ nitro, C₁₋₁₀ cyano a halide (F, Cl, Br, I), and a 5- or 6 membered heterocycle containing from 1 to 4 heteroatoms selected from oxygen, sulfur, nitrogen, and phosphorous,

wherein the copolymerisation is carried out by sequential polymerisation of the first and second cyclic ester; and

preferably wherein X is N, R⁵, R⁷ and R⁸ are hydrogen and/or R⁴ and R⁶ are independently selected from hydrogen, methyl, ethyl, propyl, isopropyl, n-butyl, i-butyl, s-butyl, t-butyl, n-pentyl, i-pentyl, neopentyl, n-hexyl, 2,2 dimethylbutane, 2-methylpentane, 3-methylpentane, 2,3 dimethylbutane, cyclohexane, adamantyl, methoxide, ethoxide, (n-/t-)butoxide, aryloxide and halides;

preferably wherein R¹ is a —[CH₂—CH₂]— linking moiety R² and R³ are hydrogen and/or R⁵, R⁷ and R⁸ are hydrogen and/or R⁴ and R⁶ are tert-butyl and/or X is N and/or Z is ethyl or N(Si—CH₃)₂,

more preferably wherein the catalyst is selected from the group consisting of

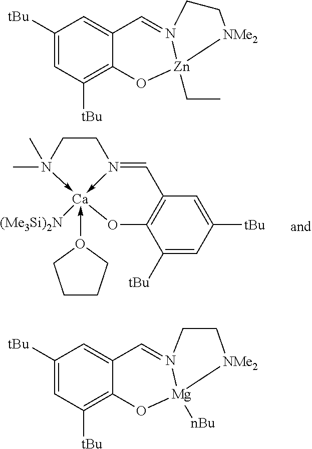

The terms “a” and “an” and “the” herein do not denote a limitation of quantity, and are to be construed to cover both the singular and the plural, unless otherwise indicated herein or clearly contradicted by context. “Or” means “and/or” unless clearly indicated otherwise. All ranges disclosed herein are inclusive of the endpoints, and the endpoints are independently combinable with each other. “Combination” is inclusive of blends, mixtures, alloys, reaction products, and the like. Furthermore, the terms “first,” “second,” and the like, herein do not denote any order, quantity, or importance, but rather are used to distinguish one element from another.

While particular embodiments have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

I/we claim:

1. A block copolymer comprising a first block of general structure 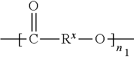
and a second block of general structure 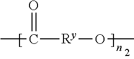
wherein
R^{x} is an organic group having a chain length of from 1-9 atoms;
R^{y} is an organic group having a chain length of from 10-38 atoms;
n₁ is at least 2; and
n₂ is at least 2.

2. A block copolymer according to claim 1 wherein the copolymer is of the type selected from the group consisting of a:
A-B di-block copolymer,
A-B-A or B-A-B tri-block copolymer,
(A-B)ₙ block copolymer wherein n is an integer and from 2-20,
(B-A)ₙ block copolymer wherein n is an integer and from 2-20,
A(B-A)ₙ block copolymer wherein n is an integer and from 2 to 20, and
B(A-B)ₙ block copolymer wherein n is an integer and from 2 to 20
wherein A represents a first block and B represents a second block.

3. A block copolymer according to claim 1 wherein said block copolymer is a linear block copolymer, a star type block copolymer or a comb-type block copolymer.

4. A block copolymer according to claim 1 further comprising a third block of general structure 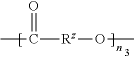
wherein
R^{z} is an organic group having a chain length of from 1-38 atoms; and
n₃ is at least 2.

5. A block copolymer according to claim 1 having a number average molecular weight Mₙ of at least 2000 gram/mole, as determined with High Temperature Size exclusion Chromatography performed at 160° C. using 1,2,4-trichlorobenzene as eluent at a flow rate of 1 mL/min and calculated with respect to polyethylene standards.

6. A block copolymer according to claim 1 having a polydispersity index, defined as Mw/Mn, of at most 3.

7. A block copolymer according to claim 1 wherein the first block is obtainable by the ring opening polymerisation of a first cyclic ester having a ring size of from 4-11 atoms and wherein the second block is obtainable by the ring opening polymerisation of a second cyclic ester having a ring size of from 12-40 atoms and wherein, if present, a third block is obtainable by the ring opening polymerisation of a third cyclic ester having a ring size of from 4-40 atoms.

8. A block copolymer according to claim 7 wherein the first and/or the second and/or, if present, the third cyclic ester is a lactone.

9. A block copolymer according to claim 7 wherein at least 80% of the total signal related to an α-methyl carbon of the first cyclic ester is present in a single peak in a ¹³C NMR spectrum of the block copolymer and at least 80% of the total signal related to an α-methyl carbon of the second cyclic ester is present in a single peak in said ¹³C NMR spectrum and, if present, at least 80% of the total signal related to an α-methyl carbon of the third cyclic ester is present in a single peak in said ¹³C NMR spectrum.

10. A method for preparing the copolymer according to claim 1 comprising providing a first cyclic ester having a ring size of from 12-40 atoms and a second cyclic ester having a ring size of from 4-11 atoms and subjecting the first and second cyclic ester to ring-opening copolymerisation using as catalyst a compound of formula I 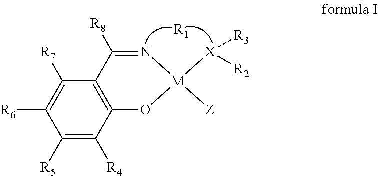
wherein
M is a metal and selected from the group consisting of group 2 metals and group 12 metals,
Z is selected from the group consisting of hydrogen, borohydrides, aluminium hydrides, carbyls, silyls, hydroxides, alkoxides, aryloxides, carboxylates, thiocarboxylates, dithiocarboxylates, carbonates, carbamates, guanidates, amides, thiolates, phosphides, hydrazonate, imide, cyanide, cyanate, thiocyanate, azide, nitro, siloxides and halides;
X is selected from the group consisting of O, N, S, and P,
R¹ is an organic linking moiety and has a chain length of at least one atom,
R² is an organic moiety selected from the group consisting of hydrogen, C₁₋₁₀ alkyl, silyl, C₁₋₆ alkoxy, C₃₋₈ cycloalkyl, C₃₋₈ cycloalkoxy, aryl, aryloxy, C₁₋₁₀ amine, C₁₋₁₀ nitro, C₁₋₁₀ cyano a halide, selected from the group consisting of F, Cl, Br, and I, 5- or 6 membered heterocycle containing from 1 to 4 heteroatoms selected from oxygen, sulfur, nitrogen, and phosphorous,
R³ is an optional organic moiety and may be the same or different as R²;
R⁴, R⁵, R⁶, R⁷ are organic moieties, may be the same or different and selected from the group consisting of hydrogen, C₁₋₁₀ alkyl, silyl, C₁₋₆ alkoxy, C₃₋₈ cycloalkyl, C₃₋₈ cycloalkoxy, aryl, aryloxy, C₁₋₁₀ amine, C₁₋₁₀ nitro, C₁₋₁₀ cyano, a halide selected from the group consisting of F, Cl, Br, and I, and a 5- or 6 membered heterocycle containing from 1 to 4 heteroatoms selected from oxygen, sulfur, nitrogen, and phosphorous,
R⁸ is an organic moiety selected from the group consisting of hydrogen, C₁₋₁₀ alkyl, silyl, C₁₋₆ alkoxy, C₃₋₈ cycloalkyl, C₃₋₈ cycloalkoxy, aryl, aryloxy, C₁₋₁₀ amine, C₁₋₁₀ nitro, C₁₋₁₀ cyano, a halide selected from the group consisting of F, Cl, Br, and I, and a 5- or 6 membered heterocycle containing from 1 to 4 heteroatoms selected from oxygen, sulfur, nitrogen, and phosphorous,
wherein the copolymerisation is carried out by sequential polymerisation of the first and second cyclic ester.

11. The method according to claim 10 wherein metal M is selected from the group consisting of calcium, zinc, and magnesium.

12. The method according to claim 10 wherein R₁ is a straight or branched aliphatic chain, or cyclic or aromatic moiety, that contains 2 to 30 carbon atoms, optionally containing 1 to 10 heteroatoms selected from N, O, F, Cl and Br.

13. The method according to claim 10 wherein
X is N,
R⁵, R⁷ and R⁸ are hydrogen, and/or
R⁴ and R⁶ are independently selected from hydrogen, methyl, ethyl, propyl, isopropyl, n-butyl, i-butyl, s-butyl, t-butyl, n-pentyl, i-pentyl, neopentyl, n-hexyl, 2,2 dimethylbutane, 2-methylpentane, 3-methylpentane, 2,3 dimethylbutane, cyclohexane, adamantyl, methoxide, ethoxide, (n-/t-)butoxide, aryloxide and halides.

14. The method according to claim 10 wherein
R¹ is a —[CH₂—CH₂]— linking moiety R² and R³ are hydrogen, and/or
R⁵, R⁷ and R⁸ are hydrogen, and/or
R⁴ and R⁶ are tert-butyl, and/or
X is N, and/or
Z is ethyl or N(Si—CH₃)₂.

15. The method according to claim 1 wherein the catalyst is selected from the group consisting of

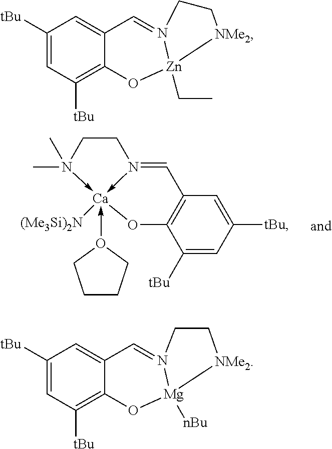

16. A block copolymer according to claim 6 having a polydispersity index, defined as Mw/Mn, of from 1-3, more preferably from 1-2.

17. The method according to claim 11, wherein metal M is calcium or zinc.
